(19) United States
(12) Patent Application Publication
(10) Pub. No.: US 2026/0226752 A1
(43) Pub. Date: Aug. 6, 2026

(54) ELEVATED VIDEOGRAPHY PLATFORM

(71) Applicant: Solysiah Vania Brown Ton, Allen, TX (US)

(72) Inventor: Solysiah Vania Brown Ton, Allen, TX (US)

(21) Appl. No.: 19/530,534

(22) Filed: Feb. 5, 2026

Related U.S. Application Data
(60) Provisional application No. 63/754,018, filed on Feb. 5, 2025.

(51) Int. Cl. E04G 1/38; A63C 19/00; E04G 1/22; G03B 17/56

(52) U.S. Cl. CPC E04G 1/38; A63C 19/005; E04G 1/22; G03B 17/561

(57) ABSTRACT

An elevated videography platform to facilitate videography of a physical competition inside a fighting cage or fenced ring includes a platform having a planar configuration defining a peripheral edge and a boundary wall or lip extending upwardly from the peripheral edge. The platform is coupled to a post at an elevated position that enables a videographer to stand on that platform and shoot video downwardly on a martial arts contest without interruption from the contest ring, fencing, or walls.

### REFERENCE TO RELATED APPLICATIONS

This application is a non-provisional patent application that claims priority based on provisional patent application U.S. Ser. No. 63/754,018 titled ELEVATED VIDEOGRAPHY PLATFORM filed Feb. 5, 2025, which is incorporated herein in its entirety.

### BACKGROUND OF THE INVENTION

This invention relates generally to videography platforms and, more particularly, to an elevated an adjustable perch that enables a videographer to shoot video from an elevated position about a martial arts contest.

Capturing a martial arts contest on video presents a unique set of challenges. One of the primary challenges is the constant movement of the fighters. Martial arts contests are intensely dynamic, with rapid exchanges of punches and kicks, evasive maneuvers, and sudden changes in direction. Traditional tripod-mounted cameras may struggle to follow the action smoothly, resulting in shaky or out-of-frame shots. Another significant challenge is the ring itself. The confined space, the presence of ropes and posts, and the presence of referees and corner teams can easily obstruct the view, to the immense frustration of the spectators.

Various strategies and technologies have been developed to capture unobstructed video of martial arts contests. These necessarily involve placing cameras strategically in relation to the ring. Common video systems include overhead cameras, corner-mounted cameras, and ringside cameras. Each camera is assigned a specific role in order to provide diverse angles and comprehensive coverage of the fight. The role of the overhead camera is to provide a bird's eye view of the action. This vantage point is critical and particularly useful for showing the movement patterns of the fighters and the overall flow of the match. Overhead cameras are typically supported by cable-suspension systems (e.g., Skycam) or ceiling-mounted rails that allow the camera to move fluidly above the contest area. These systems are controlled by remote operators using joysticks and other controls to adjust the position and angle of the camera. However, this type of technology is usually quite complex and sophisticated and requires extensive training. It is also expensive. Therefore, a simpler solution would be an adjustable platform mounted onto the fight cage or ring allowing a camera technician to film the action from directly overhead.

Therefore, it would be desirable to have an adjustable platform that mounts on to fight cages and boxing rings and provides camera technicians a standing platform from which to video the action without interference. Further, it would be desirable to have an adjustable platform 24″×24″ that attaches securely to a 4″×4″ square post and is specifically engineered to support the weight of a camera technician. Even further, it would be desirable to have an adjustable platform the key components of which include a diamond-plated platform, upper and lower support clamps, and 2 angled support beams, all constructed of 3/16″ welded steel. Additionally, the platform would have a raised edge as a distinct boundary for the camera operator.

### SUMMARY OF THE INVENTION

This invention is directed to a videography platform that enables a videographer to shoot video from an elevated position above a martial arts ring.

In one aspect, an elevated videography platform is provided for facilitating videography of a physical competition occurring inside a fighting cage or fenced ring. The platform includes a planar platform defining a peripheral edge and a boundary lip extending upwardly from the peripheral edge. A vertically adjustable post is coupled to the planar platform, the post having telescoping sections and a locking mechanism configured to selectively fix the planar platform at a plurality of elevated heights above a supporting surface. A stabilization system is coupled to the post and includes at least one outwardly extending stabilizing member configured to engage the supporting surface to resist lateral movement of the post. In this manner, the planar platform is supported at an elevated position above the fighting cage or fenced ring at a height sufficient to permit a videographer standing on the planar platform to capture downward video footage of the physical competition without visual obstruction from fencing, cage walls, or ring structures.

Therefore, a general object of this invention is to provide a videography platform that provides a “perch” elevated above a martial arts ring and fence so that clear video recording can be made without interference from ring fencing or by participant teams or personnel.

Another object of this invention is to provide a videography platform, as aforesaid, that includes a platform, upper and lower support clamps, and angled support beams.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a perspective view of an elevated videography platform according to a preferred embodiment of the present invention, illustrated in use with a fighting ring;

FIG. 1b is an isolated view on an enlarged scale taken from FIG. 1a;

FIG. 2 is perspective view of the videography platform as in FIG. 1, illustrated apart from the fighting ring; and

FIG. 3 is an exploded view of the videography platform as in FIG. 2.

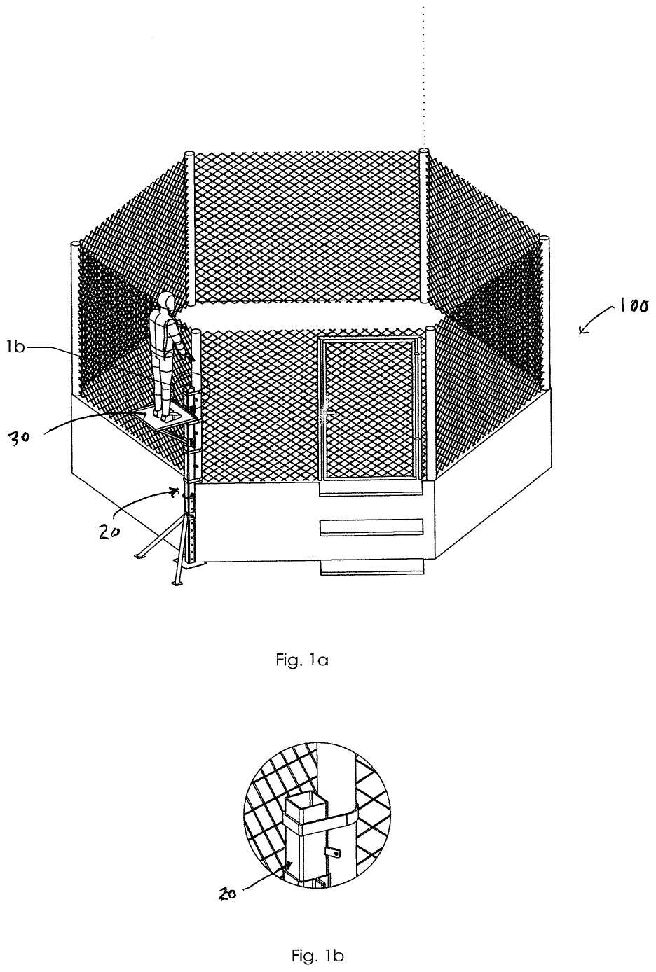

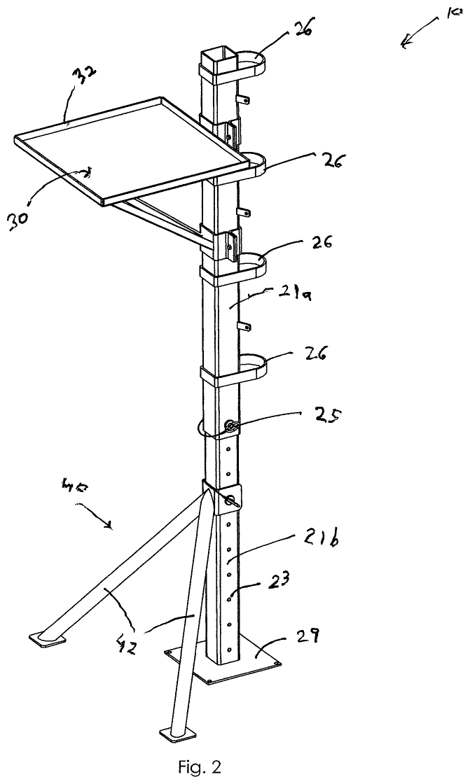

### DESCRIPTION OF THE PREFERRED EMBODIMENT

A videography platform according to a preferred embodiment of the present invention will now be described with reference to the accompanying drawings.

The videography platform 10 includes support post 20 having a lower end that may be mounted to a floor surface, to a framework, or even to the martial arts ring 100. Preferably, the support post 20 is a 4″×4″ square post such as square tubing and may have an elongate and linear configuration that defines a longitudinal axis extending vertically into the air.

The videography platform 10 may include a platform 30 having a generally planar surface defining a 24″×24″ surface that is suitable for a videographer to stand upon. Preferably, the platform 30 has a metal construction such as steel or aluminum or may include a metal webbing such as a grate. The platform 30 is displaced upwardly from the lower end so that the platform 30 is elevated above a floor surface and such that video footage may be shot from above the ring and fencing or walls. In an embodiment, the platform 30 may be diamond plated and may include a lip 32 extending upwardly from a peripheral edge of the planar surface of the platform, the lip 32 providing a tactile boundary that indicates to a videographer that he has reached the edge of the platform 30. The lip 32 is an important safety device so that the videographer does not fall from his perch.

Further, the platform 30 may be further supported by a pair of support beams 22 extending at an angle between a bottom surface of the platform 30 and the support post 20. In an embodiment, auxiliary mounting structures that allow the platform 30 to be slidably movable or selectively positioned may also be included. In an embodiment, upper and lower support clamps 26 may also be utilized in the support structure.

In certain embodiments, the post 20 that supports the planar platform 30 may be configured to permit selective vertical adjustment of the height of the planar platform 30 relative to a supporting surface. The post 20 may include two or more telescoping sections 21a, 21b arranged to slide relative to one another along a vertical axis. The relative position of the telescoping sections may be selectively fixed to establish a desired elevation of the planar platform 30 above the ground, floor, or other supporting surface. The selective fixing of the telescoping sections may be accomplished by any suitable locking structure, including but not limited to aligned apertures 23 formed through overlapping portions of the telescoping sections and a removable locking pin 25, a clamp collar configured to frictionally engage the telescoping sections, a threaded engagement mechanism, a detent system, or other mechanical locking arrangements capable of maintaining the platform 30 at a selected height while bearing the weight of a videographer.

The vertical adjustability of the post 20 allows the planar platform 30 to be raised to an elevation sufficient to position a videographer above the upper boundary of a fighting cage, fenced ring, or similar enclosure, thereby ensuring a clear, unobstructed downward filming angle regardless of variations in cage height, ring configuration, or venue layout.

In some embodiments, the elevated videography platform 30 may further include a stabilization system 40 associated with the post 20 to resist lateral movement, tipping, or swaying of the platform 30 while a videographer is standing thereon. The stabilization system 40 may include one or more stabilizing members 42 extending outwardly from a lower portion of the post 20 to engage the supporting surface. Such stabilizing members 42 may include radially extending legs, braces, outriggers, or similar structures configured to increase the effective footprint of the post 20 on the supporting surface.

In addition or alternatively, the stabilization system 40 may include a weighted base 29 coupled to a lower end of the post 20 to lower the center of gravity of the elevated videography platform. The weighted base may be integral with the post or removably attachable thereto for ease of transport and setup.

In further embodiments, one or more braces may extend between the post 20 and the planar platform to provide additional rigidity and resistance to oscillation or deflection when the platform is occupied. These braces may be fixed or detachable and may extend at angled orientations relative to the post.

The post may also be configured to be temporarily or permanently secured to a fixed structure within a venue, such as a floor surface, wall surface, railing, or other structural element, to further enhance stability during use.

The planar platform 30 itself may include surface features that enhance the safety and stability of a videographer standing thereon. For example, the upper surface of the planar platform may include a textured, anti-slip surface treatment. Additionally, the planar platform may include one or more anchor points configured to receive a safety tether or harness worn by the videographer.

The boundary wall or lip 32 extending upwardly from the peripheral edge of the planar platform 30 may extend continuously around the entire peripheral edge or may be formed in discrete sections positioned to prevent inadvertent stepping off the platform while still allowing convenient access onto and off of the platform 30.

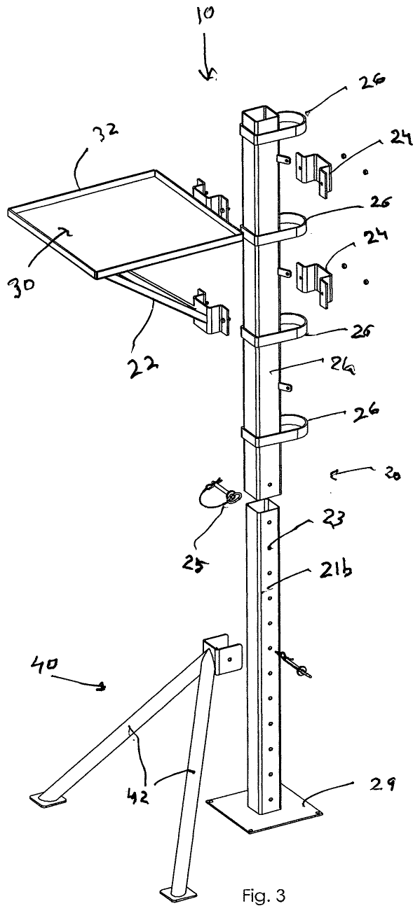

The post 20 and planar platform 30 may be detachably coupled to permit disassembly of the elevated videography platform 30 for transport, storage, and rapid assembly at different event locations. Platform mounting clamps 24 are shown in FIG. 3.

These features collectively allow the elevated videography platform 30 to be safely deployed in a variety of event venues while providing a stable, adjustable, and secure elevated position from which a videographer can capture unobstructed overhead footage of a martial arts contest or other physical competition occurring within a fenced or enclosed ring.

It is understood that while certain forms of this invention have been illustrated and described, it is not limited thereto except insofar as such limitations are included in the following claims and allowable functional equivalents thereof.

1. An elevated videography platform for facilitating videography of a physical competition inside a fighting cage or fenced ring, the platform comprising:
a post having an elongate and linear configuration;
a platform coupled to said post and held at an elevated position, said platform having a planar configuration and having a peripheral edge;
a boundary wall or lip extending upwardly from the peripheral edge of the platform;
wherein said platform enables a videographer to stand thereon and shoot video downwardly on a martial arts contest without interruption from the contest ring, fencing, or walls.

2. The elevated videography platform of claim 1, wherein the planar platform is made of a material selected from the group consisting of metal, composite materials, or reinforced plastic to provide structural strength and stability.

3. The elevated videography platform of claim 1, wherein the boundary wall or lip extends upwardly from the peripheral edge to a height sufficient to provide safety and prevent the videographer from stepping off the edge.

4. The elevated videography platform of claim 1, wherein the post includes an adjustable height mechanism to allow the planar platform to be raised or lowered to a desired elevation.

5 . The elevated videography platform of claim 4, wherein the adjustable height mechanism comprises a telescoping post structure with locking mechanisms at predetermined intervals.

6. The elevated videography platform of claim 1, further comprising a stabilization system, wherein the stabilization system includes at least one of:
stabilizing arms extending from the post to the ground or adjacent structures;
a weighted base attached to the post.

7. The elevated videography platform of claim 1, wherein the planar platform includes an anti-slip surface to enhance the videographer's stability while standing on the platform.

8. The elevated videography platform of claim 1, further comprising a safety harness attachment point on the planar platform to allow the videographer to secure themselves to the platform.

9. The elevated videography platform of claim 1, wherein the post is configured to be detachably coupled to the planar platform, allowing for disassembly and transport of the platform.

10. The elevated videography platform of claim 1, wherein the post is configured to be mounted to a fixed structure within the venue, providing additional stability to the elevated platform.

11. An elevated videography platform for facilitating videography of a physical competition occurring inside a fighting cage or fenced ring, the elevated videography platform comprising:
a planar platform defining a peripheral edge;
a boundary lip extending upwardly from the peripheral edge of the planar platform;
a vertically adjustable post coupled to the planar platform, the post including a telescoping section and a locking mechanism configured to selectively fix the planar platform at a plurality of elevated heights above a ground surface; and
a stabilization system coupled to the post, the stabilization system including at least one outwardly extending stabilizing member configured to engage a supporting surface to resist lateral movement of the post,
wherein the planar platform is supported at an elevated position above the fighting cage or fenced ring at a height sufficient to permit a videographer standing on the planar platform to capture downward video footage of the physical competition without visual obstruction from fencing, cage walls, or ring structures.

12. The elevated videography platform of claim 1, wherein the stabilization system further includes a weighted base positioned at a lower end of the post.

13. The elevated videography platform of claim 1, wherein the outwardly extending stabilizing member comprises a plurality of radially extending legs configured to contact the ground surface.

14. The elevated videography platform of claim 1, wherein the locking mechanism comprises aligned apertures formed in overlapping telescoping sections and a removable locking pin.

15. The elevated videography platform of claim 1, wherein the locking mechanism comprises a clamp collar configured to frictionally secure the telescoping section.

16. The elevated videography platform of claim 1, wherein the planar platform further includes an anti-slip upper surface.

17 . The elevated videography platform of claim 1, further comprising a safety anchor point formed on the planar platform for receiving a tether or harness.

18. The elevated videography platform of claim 1, wherein the boundary lip extends continuously around the entire peripheral edge of the planar platform.

19. The elevated videography platform of claim 1, wherein the stabilization system includes at least one brace extending between the post and the planar platform.

20. The elevated videography platform of claim 1, wherein the post is detachably coupled to the planar platform to permit disassembly for transport.
